(19) United States
(12) Patent Application Publication
(10) Pub. No.: US 2020/0329015 A1
(43) Pub. Date: Oct. 15, 2020

(54) METHOD AND SYSTEM FOR ANONYMIZATION AND EXCHANGE OF ANONYMIZED DATA ACROSS A NETWORK

(71) Applicant: OTONOMO TECHNOLOGIES LTD., Even Yehuda (IL)

(72) Inventors: Yosef Haim ITZKOVICH, Raanana (IL); Tomer RAANAN, Ganey Tikva (IL); Maayan SAGIR, Tel Aviv (IL); Avner COHEN, Kfar Haoranim (IL)

(73) Assignee: OTONOMO TECHNOLOGIES LTD., Even Yehuda (IL)

(21) Appl. No.: 16/305,423

(22) PCT Filed: May 29, 2017
(86) PCT No.: PCT/IL2017/050602

§ 371 Date: Nov. 29, 2018

Related U.S. Application Data
(60) Provisional application No. 62/343,876, filed on Jun. 1, 2016.

(51) Int. Cl. H04L 29/06; G06F 21/62

(52) U.S. Cl. CPC H04L 63/0407; H04L 2209/84; H04L 63/0209; G06F 21/6245

(57) ABSTRACT

Some embodiments of the present invention provide a system and a method for anonymizing unique identifiers of objects on a networked database and for exchange of anonymized data across a network. A personalized database holding unique identifiers of users and/or entities may use a module to anonymize the unique identifiers of the users or entities and convert it to anonymized identifiers using an asymmetric conversion. In consequence, no unique identifier of any user or entity get out of the personalized database. A third-party application can request the matched anonymized token for a given user identifier. The anonymized token is generated using a symmetric conversion and is unique per third party application. Then, the third-party application can retrieve data related to the unique identifier using the anonymized token. The data is only retrieved using the anonymized token only.

### FIELD OF THE INVENTION

The present invention relates generally to the field of data anonymizing, and more particularly to data anonymizing of unique identifiers of objects monitored on a networked database, and the exchange of anonymized data across a network.

### BACKGROUND OF THE INVENTION

Prior to setting forth the background of the invention, it may be helpful to set forth definitions of certain terms that will be used hereinafter.

The term “unique identifier” as used herein is defined as a personalized identifier of an object and/or a unique identifier of an object.

The term “unidirectional conversion” as used herein is defined as an asymmetric conversion of one object (e.g. number, character or combinations of numbers or characters) to another that does not allow reconstructing the original object from the converted value. A “bi-directional conversion” on the other hand or a “symmetric conversion” allows recalculating the original value from the converted value and vice versa.

The term “private zone” as used herein is defined as part of a computer network and/or cloud that hold data that may be identified to be associated with specific users or objects.

The term “anonymized zone” as used herein is defined as part of a computer network that hold data that may not be identified as associated with specific users or objects, inside the zone. At the same time, outside the anonymized zone, it is possible to associate data in the anonymized zone to specific users or objects.

In many cloud-based systems there is a need to anonymize the unique identifiers of certain objects in order to maintain their user's privacy, and/or secure business confidential information. The use of keys or temporary tokens is known in the art but is somewhat insufficient for large distributed systems that aggregate transfer and exchange personalized data and/or confidential data from various sources and need to maintain the data on anonymized networks and databases.

The term “personalized database” as used herein is defined as a database holding identifiers of persons, and/or entities (such as vehicles, interjections etc.), and/or non-physical entities (such as processes, locations, trips and the like).

The term “cloud” as used herein is defined as a cloud and/or a computer system including computer networks.

The term “server” as used herein may refer to one or more physical servers, one or more software servers or combinations of the two.

### SUMMARY OF THE INVENTION

Some embodiments of the present invention provide a system and a method for anonymizing unique identifiers of objects on a networked/cloud database. A personalized database holding unique identifiers of users or objects may use a module to anonymize the unique identifiers of the users/objects and convert it to anonymized identifiers using an asymmetric conversion. In consequence, no unique identifier of any user/object get out of the personalized database.

A third party application can request the matched anonymized token for a given user identifier. The token is generated using a symmetric conversion and anonymized and unique per third party application. Then, the third party application can retrieve data using the anonymized token. The data is only retrieved using the anonymized token only. Furthermore, the invention below details the way several entities can exchange unique identifiers across a network or cloud, without disclosing the identifiers across the network/cloud.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram illustrating non-limiting exemplary architecture of a file system in accordance with some embodiments of the present invention;

FIG. 2 is a high level flowchart illustrating non-limiting exemplary method in accordance with some embodiments of the present invention;

FIGS. 3-6 are flow charts illustrating a non-limiting example of data anonymizing in accordance with some embodiments of the present invention; and

FIG. 7 is a block diagram illustrating an aspect according to some embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Unless specifically stated otherwise, as apparent from the following discussions, it is appreciated that throughout the specification discussions utilizing terms such as “processing,” “computing,” “calculating”, “recalculating”, “determining,” or the like, refer to the action and/or processes of a computer or computing system, or similar electronic computing device or software, that manipulates and/or transforms data represented as physical or logical, such as electronic, quantities within the computing system's registers and/or memories into other data similarly represented as physical or logical quantities within the computing system's memories, registers or other such information storage, transmission or display devices.

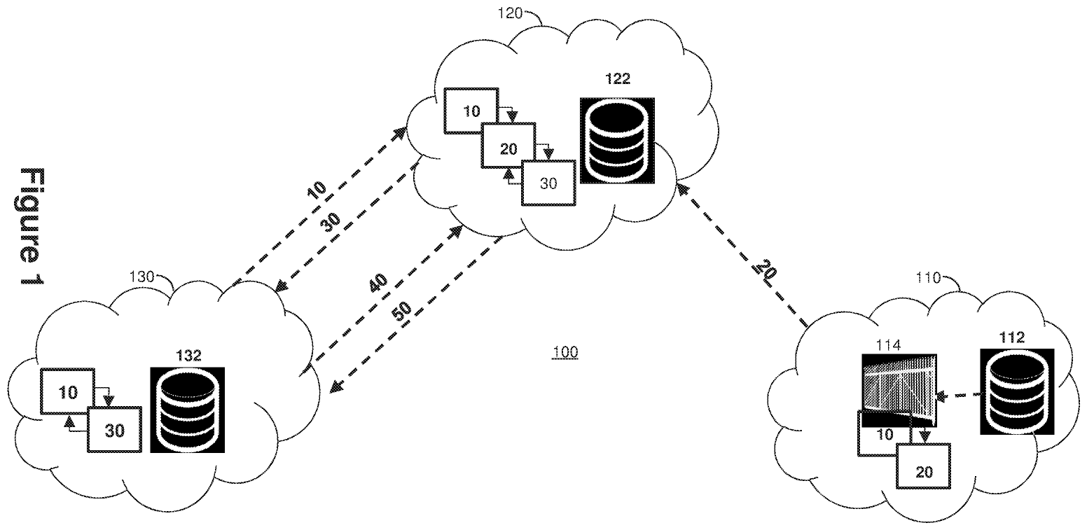

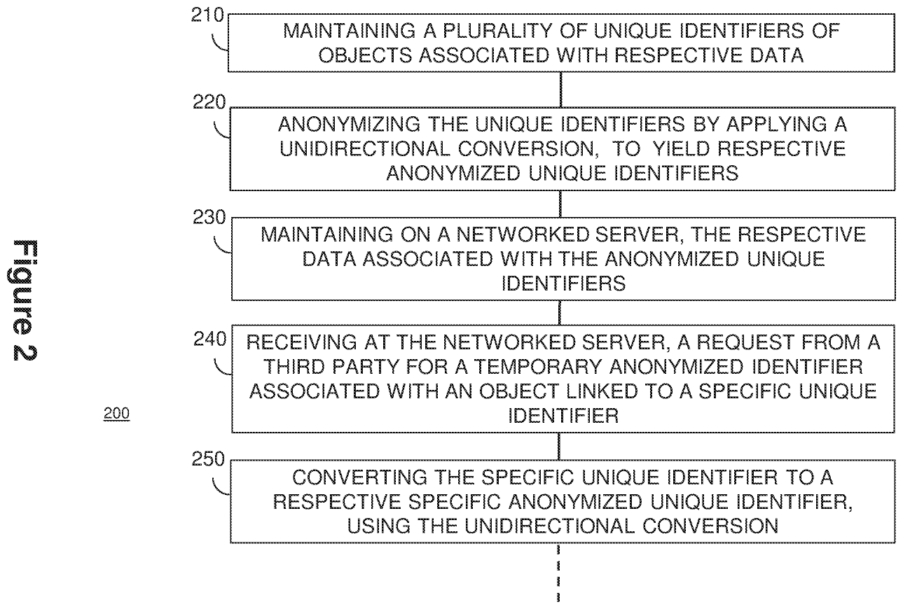

FIG. 1 is a block diagram illustrating non-limiting exemplary architecture of a computer-based system 100 in accordance with embodiments of the present invention. A system 100 for communicating anonymized data of uniquely identified objects via a computer network, is illustrated herein. The system includes: personalized database 112 configured to maintain a plurality of unique identifiers 10 of objects associated with respective data and a gatekeeper module 114 located at the personalized cloud or computer system 110, configured to anonymize the unique identifiers 10 by applying a unidirectional conversion, to yield respective anonymized unique identifiers 20. Computer system 110 may be implemented by a computer processor.

System 100 may further include a networked server 122 on an anonymized cloud or computer system 120 configured to maintain the respective data associated with the anonymized unique identifiers 20, wherein the networked server 122 is configured to: receive a request from at least one third party client 130, for a temporary anonymized identifier 30 associated with an object linked to a specific unique identifier 10; uni-directionally convert the specific unique identifier 10 to a respective specific anonymized unique identifier 20, using the unidirectional conversion; in a case the anonymized unique identifier 20 exists on the server, generate a temporary anonymized identifier 30 by applying a bi-directional conversion to the specified anonymized unique identifier 20, wherein the bi-directional conversion is specific to the at least one third party 130; receive at the networked server 120, a request 40 from the third party 130 for data associated with an object linked to a specific temporary anonymized identifier 30; convert the specific temporary anonymized identifier 30 into a respective anonymized unique identifier 20 based on the bi-directional conversion; and provide the requested data from the networked server 122 to the third party 130 based on the specific anonymized unique identifier 20 via response 50 communicated from anonymized cloud 120 to third party cloud 130. Computer system 120 may be implemented by a computer processor.

It should be note that any third party cloud 130 may keep the association of specific unique identifier 10 to the received temporary anonymized identifier 30 in an internal database, and vice versa.

According to some embodiments of the present invention, the providing of the data to the third party is only identifiable by the temporary anonymized identifier.

According to some embodiments of the present invention the unique identifiers of objects associated with respective data are obtained from a plurality of sources, each holding a database of objects and their respective data.

According to some embodiments of the present invention, the temporary anonymized identifier is associated with a predefined time span after which it ceased to be operational.

According to some embodiments of the present invention, the networked database and the personalized database may be distinct from each other and communicate over a communication channel, but they may also be collocated and only be logically separated.

According to some embodiments of the present invention, at least one third party comprises a plurality of third party clients, each associated with a unique bi-directional conversion at the networked database.

According to some embodiments of the present invention, the objects may be tangible objects such as vehicles or specific locations but also intangible objects such as trip IDs.

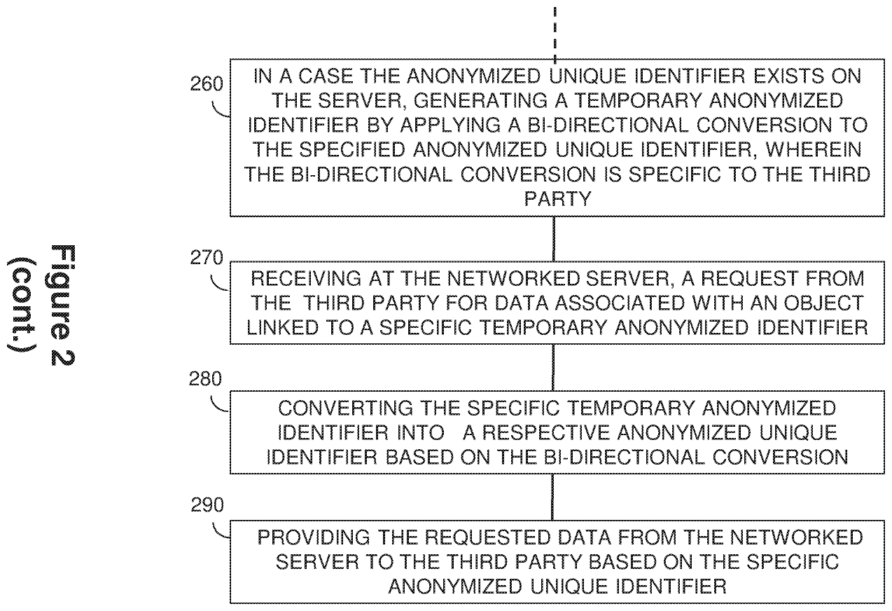

FIG. 2 is a high level flowchart illustrating non-limiting exemplary method for communicating anonymized data of unique identified objects via a computer network, in accordance with embodiments of the present invention. Method 200 may include: maintaining on a personalized database, a plurality of unique identifiers of objects associated with respective data 210; anonymizing the unique identifiers by applying a unidirectional conversion, to yield respective anonymized unique identifiers 220; maintaining on a networked server, the respective data associated with the anonymized unique identifiers 230; receiving at the networked server, a request from at least one third party for a temporary anonymized identifier associated with an object linked to a specific unique identifier 240; converting the specific unique identifier to a respective specific anonymized unique identifier, using the unidirectional conversion 250; in a case the anonymized unique identifier exists on the server, generating a temporary anonymized identifier by applying a bi-directional conversion to the specified anonymized unique identifier, wherein the bi-directional conversion is specific to the at least one third party 260; receiving at the networked server, a request from the third party for data associated with an object linked to a specific temporary anonymized identifier 270; converting the specific temporary anonymized identifier into a respective anonymized unique identifier based on the bi-directional conversion 280; and providing the requested data from the networked server to the third party based on the specific anonymized unique identifier 290.

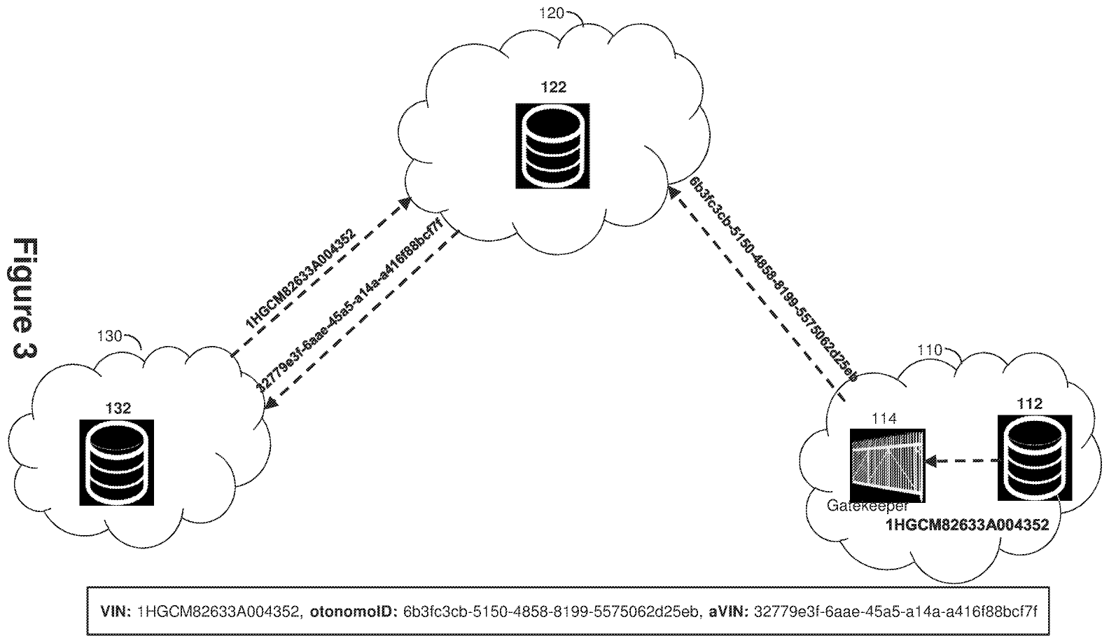

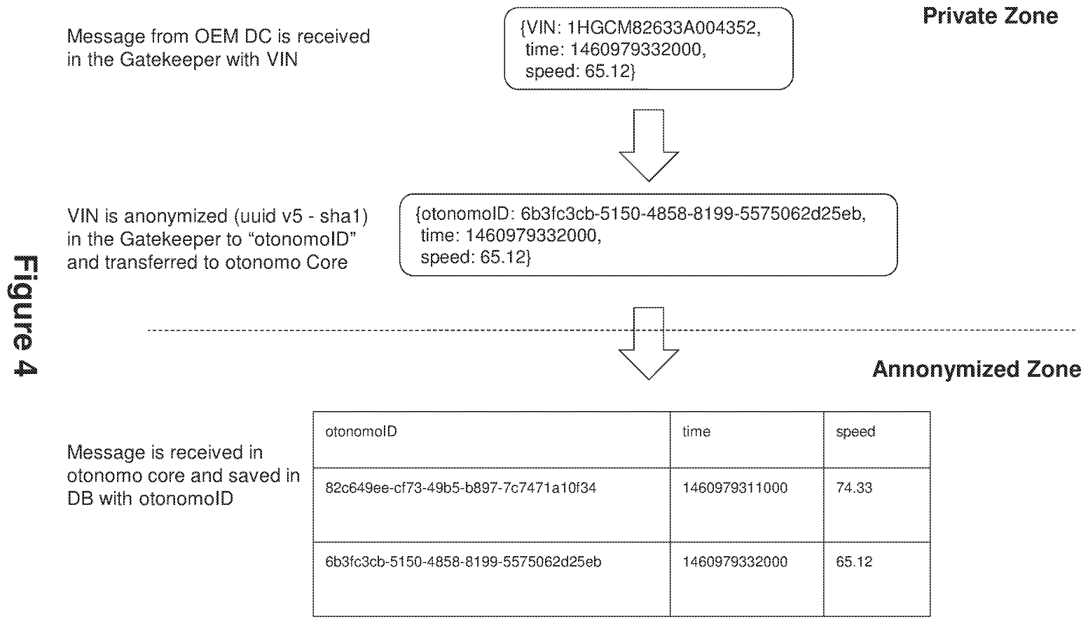

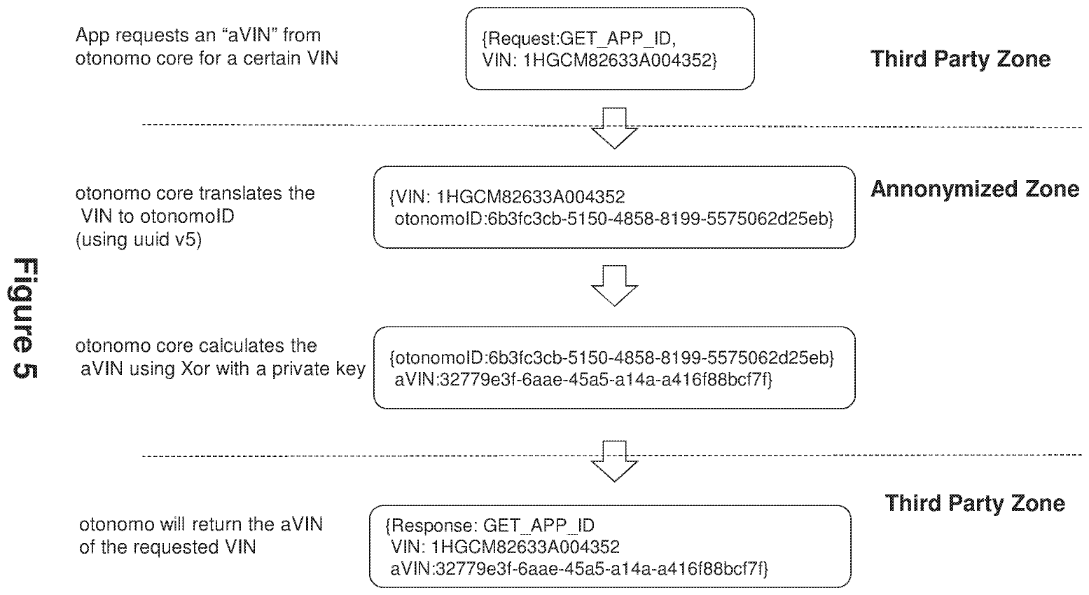

FIGS. 3-6 are flow charts illustrating a non-limiting example of data anonymization in accordance with embodiments of the present invention. For the sake of the non-limiting example, as illustrated in FIG. 3 private zone 110 holds data on database 112 associated with unique identifiers of vehicles known as vehicle identifier numbers (VIN); anonymized zone 120 hold data on database 122 which is identified by anonymized identifiers called here OtonomoID by way of example for the remainder of this document; and third party zone 130 holds data of personalized database 132 which is identified by anonymized temporary token called anonymized vehicle identifier numbers (aVIN). The flow in FIG. 4 shows how speed and time of a specify vehicle identified by a VIN is kept. The VIN is anonymized by an asymmetric conversion so at the anonymized zone the same data is kept with the OtonomoID as an anonymized identifier. In FIG. 5 the third party zone issues a request for a token (aVIN) for a specific OtonomoID which is translated by the anonymized zone into the temporary token (aVIN) and returned to the third party zone.

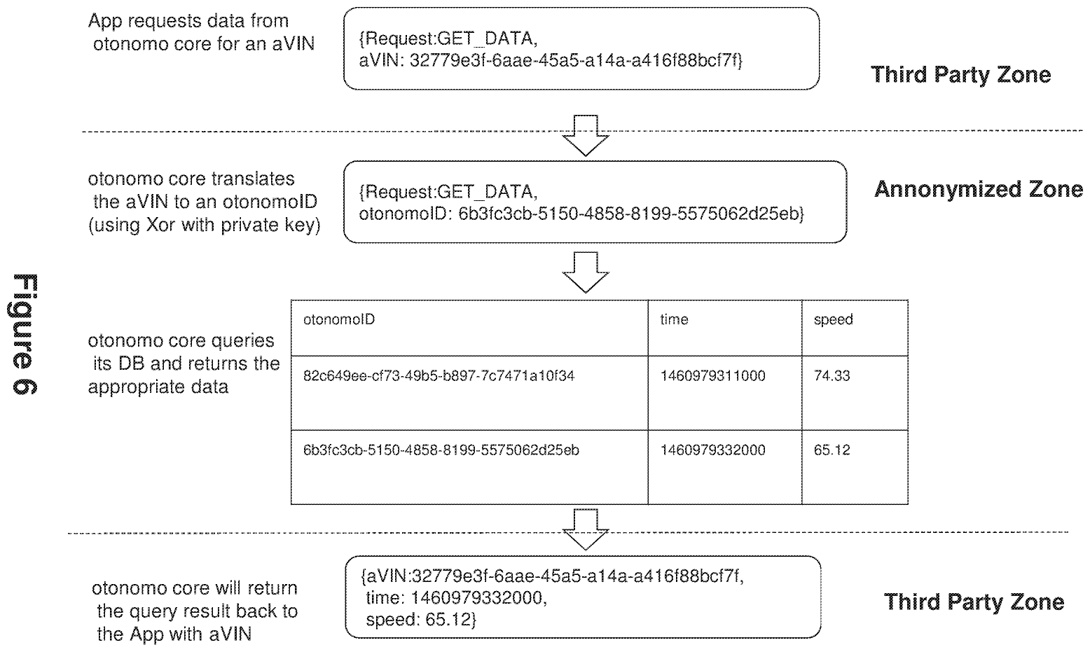

In FIG. 6 the third party zone then requests actual data for the temporary token (aVIN). The symmetric conversion is then applied at the anonymized zone and the corresponding data to the OtonomoID is then retrieved and returned to the third party zone.

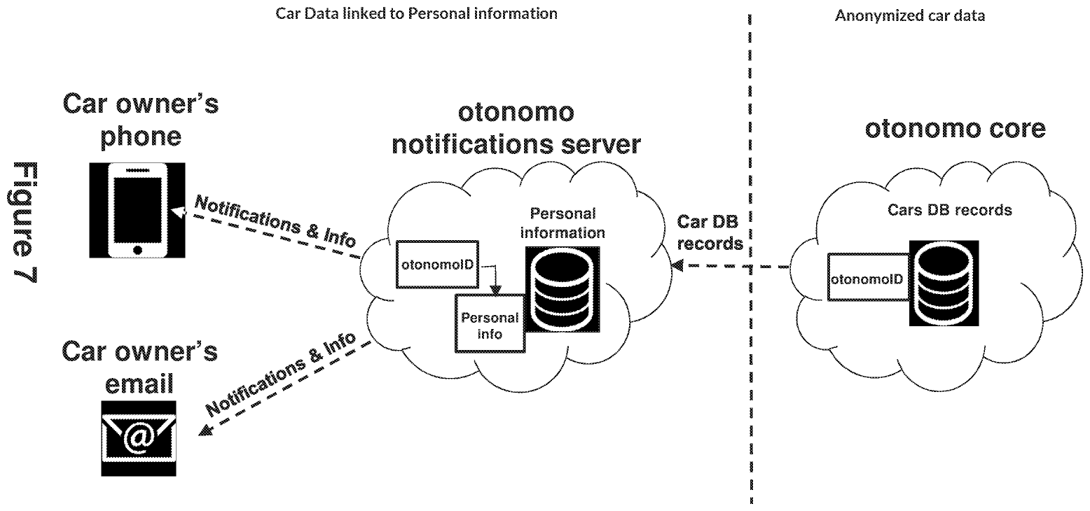

FIG. 7 is a block diagram illustrating an aspect according to some embodiments of the present invention. Here the Otonomo core which is the anonymized zone discussed above is used by a notification server in order to retrieve data relating to specific car users. Once the anonymized data is retrieved, the notification server can approach the specific car users based on the personal information that has been gathered without the actual data being exposed.

In accordance with embodiments of the present invention, the non-transitory computer readable medium may further include a set of instructions, when executed, further cause the least one processor to implement aforementioned method.

In order to implement the method according to embodiments of the present invention, a computer processor may receive instructions and data from a read-only memory or a random access memory or both. At least one of aforementioned steps is performed by at least one processor associated with a computer. The essential elements of a computer are a processor for executing instructions and one or more memories for storing instructions and data. Generally, a computer will also include, or be operatively coupled to communicate with, one or more mass storage devices for storing data files. Storage modules suitable for tangibly embodying computer program instructions and data include all forms of non-volatile memory, including by way of example semiconductor memory devices, such as EPROM, EEPROM, and flash memory devices and also magneto-optic storage devices.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in base band or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire-line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++, Python or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or portion diagrams of methods, apparatus (systems) and computer program products according to embodiments of the invention. It will be understood that each portion of the flowchart illustrations and/or portion diagrams, and combinations of portions in the flowchart illustrations and/or portion diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or portion diagram portion or portions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or portion diagram portion or portions.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or portion diagram portion or portions.

The aforementioned flowchart and diagrams illustrate the architecture, functionality, and operation of possible implementations of systems, methods and computer program products according to various embodiments of the present invention. In this regard, each portion in the flowchart or portion diagrams may represent a module, segment, or portion of code, which comprises one or more executable instructions for implementing the specified logical function(s). It should also be noted that, in some alternative implementations, the functions noted in the portion may occur out of the order noted in the figures. For example, two portions shown in succession may, in fact, be executed substantially concurrently, or the portions may sometimes be executed in the reverse order, depending upon the functionality involved. It will also be noted that each portion of the portion diagrams and/or flowchart illustration, and combinations of portions in the portion diagrams and/or flowchart illustration, can be implemented by special purpose hardware-based systems that perform the specified functions or acts, or combinations of special purpose hardware and computer instructions.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A system for communicating anonymized data obtained from vehicles via a computer network, the system comprising:
a personalized database in a private zone configured to maintain a plurality of unique identifiers of vehicles associated with respective data;
a unidirectional convertor coupled to the personalized database, and located at the private zone, configured to anonymize the unique identifiers by applying a unidirectional conversion, to yield respective anonymized unique identifiers; and
a networked server in an anonymized zone separated from the private zone and configured to maintain said respective data associated with the anonymized unique identifiers,
wherein the networked server is configured to:
receive a request from at least one third party, for a temporary anonymized identifier associated with a vehicle linked to a specific unique identifier;
convert the specific unique identifier to a respective specific anonymized unique identifier, using said unidirectional conversion;
in a case said anonymized unique identifier exists on the server, generate a temporary anonymized identifier by applying a bi-directional conversion to the specified anonymized unique identifier, wherein the bi-directional conversion is specific to said at least one third party;
receive at the networked server, a request from said third party for data associated with a vehicle linked to a specific temporary anonymized identifier;
convert the specific temporary anonymized identifier into a respective anonymized unique identifier based on the bi-directional conversion; and
provide the requested data from the networked server to said third party based on the specific anonymized unique identifier.

2. The system according to claim 1, wherein the providing of the data to the third party is only identifiable by the temporary anonymized identifier.

3. The system according to claim 1, wherein the unique identifiers of vehicles associated with respective data are obtained from a plurality of sources, each holding a database of vehicles and their respective data.

4. The system according to claim 1, wherein the temporary anonymized identifier is associated with a predefined time span after which it ceased to be operational.

5. The system according to claim 1, wherein the networked database and the personalized database are distinct from each other and communicate over a communication channel.

6. The system according to claim 1, wherein said at least one third party comprises a plurality of third party clients, each associated with a unique bi-directional conversion at the networked database.

7. The system according to claim 1, wherein the unique identifiers are unique identifiers of at least one of the elements of the vehicles.

8. A method for communicating anonymized data of unique identified vehicles via a computer network, the method comprising:
maintaining on a personalized database, a plurality of unique identifiers of vehicles associated with respective data;
anonymizing the unique identifiers by applying a unidirectional conversion, to yield respective anonymized unique identifiers;
maintaining on a networked server, said respective data associated with the anonymized unique identifiers;
receiving at the networked server, a request from at least one third party for a temporary anonymized identifier associated with a vehicle linked to a specific unique identifier;
converting the specific unique identifier to a respective specific anonymized unique identifier, using said unidirectional conversion;
in a case said anonymized unique identifier exists on the server, generating a temporary anonymized identifier by applying a bi-directional conversion to the specified anonymized unique identifier, wherein the bi-directional conversion is specific to said at least one third party;
receiving at the networked server, a request from said third party for data associated with a vehicle linked to a specific temporary anonymized identifier;
converting the specific temporary anonymized identifier into a respective anonymized unique identifier based on the bi-directional conversion; and
providing the requested data from the networked server to said third party based on the specific anonymized unique identifier.

9. The method according to claim 8, wherein the providing of the data to the third party is only identifiable by the temporary anonymized identifier.

10. The method according to claim 8, wherein the unique identifiers of vehicles associated with respective data are obtained from a plurality of sources, each holding a database of vehicles and their respective data.

11. The method according to claim 8, wherein the temporary anonymized identifier is associated with a predefined time span after which it ceased to be operational.

12. The method according to claim 8, wherein the networked database and the personalized database are distinct from each other and communicate over a communication channel.

13. The method according to claim 8, wherein said at least one third party comprises a plurality of third party clients, each associated with a unique bi-directional conversion at the networked database.

14. The method according to claim 8, wherein the unique identifiers are unique identifiers of at least one of the elements of the vehicles.

15. A non-transitory computer readable medium for communicating anonymized data of unique identified vehicles via a computer network, wherein the computer readable medium comprising a set of instructions that when executed cause at least one computer processor to:
maintain, on a personalized database, a plurality of unique identifiers;
anonymize the unique identifiers, at the personalized database, by applying a unidirectional conversion, to yield respective anonymized unique identifiers;
maintain, on a networked database, said respective data associated with the anonymized unique identifiers;
receive a request from at least one third party, for a temporary anonymized identifier associated with a vehicle linked to a specific unique identifier;
convert the specific unique identifier to a respective specific anonymized unique identifier, using said unidirectional conversion;
in a case said anonymized unique identifier exists on the server, generate a temporary anonymized identifier by applying a bi-directional conversion to the specified anonymized unique identifier, wherein the bi-directional conversion is specific to said at least one third party;
receive at the networked server, a request from said third party for data associated with a vehicle linked to a specific temporary anonymized identifier;
convert the specific temporary anonymized identifier into a respective anonymized unique identifier based on the bi-directional conversion; and
provide the requested data from the networked server to said third party based on the specific anonymized unique identifier.

16. The non-transitory computer readable medium according to claim 15, wherein the providing of the data to the third party is only identifiable by the temporary anonymized identifier.

17. The non-transitory computer readable medium according to claim 15, wherein the unique identifiers of vehicles associated with respective data are obtained from a plurality of sources, each holding a database of vehicles and their respective data.

18. The non-transitory computer readable medium according to claim 15, wherein the temporary anonymized identifier is associated with a predefined time span after which it ceased to be operational.

19. The non-transitory computer readable medium according to claim 15, wherein the networked database and the personalized database are distinct from each other and communicate over a communication channel.

20. The non-transitory computer readable medium according to claim 15, wherein said at least one third party comprises a plurality of third party clients, each associated with a unique bi-directional conversion at the networked database.

21. (canceled)
